(19) United States
(12) Patent Application Publication
(10) Pub. No.: US 2011/0288190 A1
(43) Pub. Date: Nov. 24, 2011

(54) METHOD FOR TREATING A MATERIAL DERIVED FROM RECOVERY AND GRINDING

(75) Inventors: Frederic Viot, Lyon (FR); Jacques Guillet, L'Arbresle (FR); Philippe Cassagnau, Millerie (FR); Valerie Massardier-Nageotte, Villeurbanne (FR); Rodolphe Sonnier, Ales (FR)

(73) Assignee: COMPAGNIE PLASTIC OMNIUM, Lyon (FR)

(21) Appl. No.: 13/131,380

(22) PCT Filed: Nov. 30, 2009
(86) PCT No.: PCT/FR2009/052341

§ 371 Date: Aug. 5, 2011

(30) Foreign Application Priority Data
Dec. 1, 2008 (FR) 0858167

(51) Int. Cl. C08J 11/04; C08L 23/10

(52) U.S. Cl. 521/47; 525/322

(57) ABSTRACT

A method of treating a material derived from recovery and shredding, the material comprising a mixture of polypropylene and polyethylene, wherein the material is mixed with 1% to 5% by weight of copolymer of ethylene-α-olefin type.

### CROSS-REFERENCE TO RELATED APPLICATIONS

This application is the U.S. National Phase application of PCT/FR2009/052341 filed Nov. 30, 2009, which claims priority to French Application No. 0858167 filed Dec. 1, 2008, which applications are incorporated herein by reference and made a part hereof.

### BACKGROUND OF THE INVENTION

1. Field of the Invention

The invention relates to the field of treating materials derived from recycling motor vehicles.

2. Description of the Related Art

Numerous motor vehicle parts are made out of plastics materials. At the end of life, such parts can be recovered and recycled so as to be used in other applications.

For this purpose, a first step consists in sorting scrap vehicle parts as a function of their respective main materials. Thereafter, the parts are shredded, and non-ferrous metals are recovered by magnetization and by eddy currents. The remaining shredded material is referred to as auto shredder residue (ASR) or “fluff”. This fluff generally contains a mixture of various plastics materials, such as, for example, polypropylene (PP) and polyethylene (PE), together with various other materials such as wood, various foams, fabrics, etc.

In order to be suitable for recycling and reuse, it is preferable for the fluff to be as pure as possible, i.e., for it to contain a large majority of a single type of plastics material. The presence of several plastics materials in the residue generally gives rise to physical and mechanical properties that are not as good as those of a material that is almost pure.

In particular, the presence of polyethylene mixed in the polypropylene spoils the mechanical properties of polypropylene such as impact strength or breaking elongation.

That is why it is necessary to have an additional step of treating the fluff in order to reduce the quantity of polyethylene relative to the quantity of polypropylene. It is generally desirable to obtain a mixture having less than 5% polyethylene.

At present, such treatment is relatively complex and expensive to implement since it consists either in setting up high-performance sorting systems seeking to separate the polyethylene from the polypropylene, or else in diluting mixtures of polypropylene and polyethylene with virgin polypropylene, which is expensive.

### SUMMARY OF THE INVENTION

A particular object of the invention is to provide a method of treating a material derived from recycling that comprises a mixture of polypropylene and polyethylene, which method is simpler and less expensive than known methods.

To this end, one embodiment of the invention provides a method of treating a material derived from recovery and shredding, the material comprising a mixture of polypropylene and of polyethylene, wherein the material is mixed with 1% to 5% by weight of copolymer of the ethylene-α-olefin type.

Tests have shown that adding a small amount (lying in the range 1% to 5%) of ethylene-α-olefin type copolymer to a mixture of polypropylene and polyethylene makes it possible to obtain a material having mechanical performance that is substantially identical to that of virgin polypropylene. The copolymer has a compatibilizing effect on the mixture of polypropylene and polyethylene.

This treatment operation is found to be particularly simple and inexpensive compared with treatment methods known in the state of the art, and it makes it possible to obtain a material that has practically the same properties as a virgin polypropylene. Furthermore, the method of the invention enables materials to be treated in which the polyethylene content may be as high as 30%.

The quantity of copolymer to be added to the mixture has no need to be very great, and it may be limited to 5%.

Because the material is derived from recovery and shredding, it includes a small proportion of in situ elastomer derived from the polypropylene being polymerized while it was being synthesized. These traces of elastomer in the mixture facilitate the compatibilizing effect of the copolymer, even when only a small quantity is mixed in.

If the mixture of polypropylene and polyethylene were to be made from a virgin polypropylene, i.e., a polypropylene not derived from recovery and shredding, then a larger quantity of copolymer (e.g., greater than 20%) would be necessary in order to restore to the polypropylene the mechanical properties that it lost on being mixed with polyethylene. In the absence of traces of elastomer resulting from polymerization of the polypropylene reduces the compatibilizing effect of the copolymer.

Thus, this method of treating a mixture of polypropylene and polyethylene is particularly adapted to treating materials derived from recovery and shredding, since the quantity of ethylene-α-olefin type copolymer that needs to be added under such circumstances is relatively small.

Once the material derived from shredding has been treated by the method of the invention, the product that results from the treatment method may be used for fabricating various parts, such as new bumpers, or other applications in which the mechanical performance of the material plays an important role.

A method of the invention may also include one or more of the following characteristics.

The material is derived from auto shredding residue or from any other source of polypropylene polluted with polyethylene, such as electrical and electronic equipment waste, for example. As mentioned in the introduction, numerous motor vehicle parts may be recycled. For example, bodywork parts such as bumpers and fuel tanks are made from the most part out of polypropylene and polyethylene, and the result of shredding them to provide pieces having an area of a few square centimeters can be treated by the method of the invention.

The copolymer of ethylene-α-olefin type is selected from any of the items of the group constituted by ethylene-octene and ethylene-butene. These two materials are particularly well adapted to implementing the method for compatibilizing a mixture of polypropylene and polyethylene.

The polypropylene is a homopolymer or copolymer polypropylene.

The polyethylene is a low, medium, or high density polyethylene.

The invention also provides a motor vehicle part made of a material comprising: polypropylene; polyethylene; and 1% to 5% by weight of copolymer of ethylene-α-olefin type.

In other words, the invention provides a motor vehicle part made of a material derived from the treatment method of the invention.

A motor vehicle part of the invention may advantageously be made with polypropylene and polyethylene derived from auto shredder residue.

Furthermore, the motor vehicle part may be a bodywork part.

### DETAILED DESCRIPTION OF THE PREFERRED EMBODIMENTS

The invention can be better understood on reading the following description given solely by way of example.

Polypropylene is a material that is commonly used for fabricating motor vehicle parts. This material is particularly advantageous because its mechanical strength characteristics are high. For a conventional virgin polypropylene, breaking stress is of the order of 19 megapascals (MPa) and breaking deformation is of the order of 500%.

When the same breaking and elongation strength tests are performed with polypropylene derived from auto shredding residue, i.e., from polypropylene mixed with a large quantity of polyethylene, it is found that breaking stress is about 16 MPa and breaking deformation is about 115%.

The presence of polyethylene in a polypropylene, in particular in auto shredding residue, therefore considerably degrades the mechanical properties of the polypropylene.

The invention proposes mixing in the range 1% to 5% of copolymer of the ethylene-α-olefin type in a material derived from auto shredding residue that comprises a mixture of polypropylene and polyethylene in order to obtain a material having mechanical properties that are close to those of a virgin polypropylene.

The copolymer of the ethylene-α-olefin type that is used may be ethylene-octene or ethylene-butene, for example.

Tests have been performed by mixing auto shredding residue with 5% of ethylene-α-olefin. The results of those tests show that the material derived from that treatment possesses breaking stress of about 20 MPa and breaking deformation of about 600%.

Consequently, it can be seen that by adding 5% of copolymer in a mixture derived from auto shredding residue, a material is obtained having mechanical properties that are substantially identical to those of a virgin polypropylene, or indeed better.

Thus, the treatment method of the invention makes it possible to recycle effectively and in simple manner polypropylene that is derived from auto shredding residue, shredding residue derived from electrical and electronic equipment waste (EEEW), or from any other source of polypropylene having mechanical properties that are degraded by the polyethylene mixed therewith.

The invention is described above with reference to the automobile industry field. Naturally, the invention is applicable to other technical fields in which there is a need to recycle parts made of polypropylene and of polyethylene for applications that require mechanical performance similar to that of a virgin polypropylene.

While the process and product herein described constitute preferred embodiments of this invention, it is to be understood that the invention is not limited to this precise process and product, and that changes may be made therein without departing from the scope of the invention which is defined in the appended claims.

What is claimed is:

1. A method of treating a material derived from recovery and shredding, the material comprising a mixture of polypropylene and of polyethylene, wherein the material is mixed with 1% to 5% by weight of copolymer of the ethylene-α-olefin type.

2. A method according to claim 1, wherein the material is derived from auto shredding residue or from any other source of polypropylene polluted with polyethylene.

3. A method according to claim 1, wherein the copolymer of ethylene-α-olefin type is selected from any of the items of the group constituted by ethylene-octene and ethylene-butene.

4. A method according to claim 1, wherein the polypropylene is a homopolymer or copolymer polypropylene.

5. A method according to claim 1, wherein the polyethylene is a low, medium, or high density polyethylene.

6. A motor vehicle part, wherein it is made of a material comprising:
polypropylene;
polyethylene; and
1% to 5% by weight of copolymer of ethylene-α-olefin type.

7. A motor vehicle part according to claim 6, wherein the polypropylene and the polyethylene are derived from auto shredder residue.

8. A motor vehicle part according to claim 6, of the bodywork part type, and wherein the polypropylene and the polyethylene are derived from auto shredder residue.

9. A method of using auto shredder residue having a mixture of polypropylene and polyethylene, comprising the steps of:
providing the auto shredder residue;
mixing 1% to 5% by weight of copolymer of ethylene-α-olefin type to obtain a material; and
using the material or providing the material to be used to make a motor vehicle part.

10. A method according to claim 9; wherein the material is derived from auto shredding residue or from any other source of polypropylene polluted with polyethylene.

11. A method according to claim 9, wherein the copolymer of ethylene-α-olefin type is selected from any of the items of the group constituted by ethylene-octene and ethylene-butene.

12. A method according to claim 9, wherein the polypropylene is a homopolymer or copolymer polypropylene.

13. A method according to claim 9, wherein the polyethylene is a low, medium, or high density polyethylene.
